(19) United States
(12) Patent Application Publication
(10) Pub. No.: US 2020/0151176 A1
(43) Pub. Date: May 14, 2020

(54) CYBER METRIC INFORMATION METHOD AND SYSTEM

(71) Applicant: Jeffery Lamonde Carter, Colorado Springs, CO (US)

(72) Inventor: Jeffery Lamonde Carter, Colorado Springs, CO (US)

(21) Appl. No.: 16/679,271

(22) Filed: Nov. 10, 2019

Related U.S. Application Data
(60) Provisional application No. 62/758,657, filed on Nov. 11, 2018.

(51) Int. Cl. G06F 16/2458; G06F 16/22; G06F 16/248; G06Q 50/18

(52) U.S. Cl. CPC G06F 16/2465; G06Q 50/184; G06F 16/248; G06F 16/2246

(57) ABSTRACT

The invention discloses a system and method for capturing institutional knowledge in the form of taxonomies and processes charts. A user creates and defines their own taxonomy, and may augment their own taxonomy by purchasing a taxonomy, finds valuable patents using the taxonomy according to analytic techniques, uploads analysis relevant to particular patents in a node, performs preliminary analysis on the patents, exports some patents to a spreadsheet and sends valuable patents off to experts for further analysis.

### CROSS REFERENCE TO RELATED APPLICATIONS

This application claims priority to U.S. Provisional Patent Application No. 62/758,657, filed on Nov. 11, 2018 and is incorporated herein by reference in its entirety.

### FIELD OF THE INVENTION

The present invention is directed to a knowledge management method and system that captures institutional knowledge in the form of taxonomies and processes charts.

### BACKGROUND OF THE INVENTION

The problem is how to capture institutional knowledge and share that within an organization. There is no knowledge management system that captures institutional knowledge in the form of taxonomies, ontologies and processes charts. This is solved by enabling an end user to define taxonomies, ontologies and processes that help them fulfill their job.

### BRIEF SUMMARY OF THE INVENTION

In accordance with one aspect of this invention, disclosed is a method and system for applying a knowledge management method and system for patent portfolios. Currently managers of patent portfolios are asked to view their company portfolio from many different perspectives. For example, which patents read against the following threat (company)? Or do we have sufficient number of patents in the following area to protect our product so we have freedom to operate? The problem is there is not a tool that allows an end user to view their patent portfolio from constantly changing perspectives. Once the end user has isolated the set of relevant patents there is not a quick effective way for the end user to determine which patents are valuable in that portfolio or to determine the value of the portfolio. This is solved by having the end user construct their own modifiable taxonomy that has persistence to search and classify documents. The end user can then use different expert systems to help determine which patents are valuable and determine the overall value of the portfolio.

Previously there was no tool that enabled an end user to create a taxonomy that is subject to change and modification. Using that taxonomy not only to search and classify documents including patents but have the taxonomy as a visual tool for patent portfolio management and search results.

Previously there was no way for an individual to custom build a taxonomy that classifies information thus giving insight to a business issue or topic.

Previously no tool gave an end user to the ability to build a taxonomy or process that has persistence that would update the nodes automatically and notify the owner or subscriber of significant information entering the taxonomy.

Buying selling taxonomies and processes: Currently you cannot purchase a taxonomy or process to help you increase your understanding of a business issue or topic. An initial step in understanding a business issue or topic is to do research to determine the state the situation or environment. Often the person tasked with solving or understanding the topic or business issue is not a subject matter expert but they are still required to understand situation and find a solution to the problem. There is currently no market, tool, or system that enables someone to purchase a taxonomy or process that would help them understand their business problem. The solution is to have a tool that enables experts to sell their taxonomies and processes to individuals that seek to understand problems relevant to the space in which the experts operate. For example, if you would like to determine which engineering solution is feasible for investment . . . or you would like to understand which car parts are available to solve a problem with your vehicle or . . . if you are tasked with determining which patents in your portfolio can help with a . . . or any number of scenarios that involve structuring knowledge into taxonomies and processes.

In accordance with another aspect of this invention, disclosed is a knowledge management method and system for an organizational explorer that identifies the key or essential human, organizational, or knowledge networks that exist besides the established organizational structure in a company. This tool solves the problem by enabling an end user to objectively determine who are the key individuals and where are the essential networks within an organization.

The organizational explorer captures organizational and functional networks to expose the institutional knowledge in an organization. Enables end users to establish ad hoc working groups wherein they build processes and taxonomies that are needed to accomplish the working groups goals and tasks.

Previously there was no way using a tool to objectively identify thought leaders, key individuals who are central or essential to a company or organization.

Previously there was no way using a tool to objectively identify the essential human, organizational, or knowledge networks in a company or organization.

Users of the cyber metric system can receive likes and respects from other users. End users can subscribe or copy taxonomies and processes. All of these give indications of key users and networks.

In accordance with another aspect of this invention, disclosed is an analytical method and system that applies an expert system to the nodes of a taxonomy as well as to the organizational explorer for deeper analysis. Expert systems analyze financial data, patent data, or the organizational network. Examples include:

A. Financial Expert Systems:
i. Financial data and patent data to determine the value of a patent portfolio.
ii. Intrinsic value tool

B. Patent Expert Systems:
i. Previous you could not determine who was leading edge by analyzing patents in a taxonomy node.
ii. Previous you could not determine which company was a leader or follower by analyzing patents in a taxonomy node.
iii. Previous there was not a tool that would prioritize patents in a taxonomy node based on potential utilization in the industry.

C. Analysis System:
i. Analyzing a patent and importing infringing evidence
ii. Highlighting novelty and have that saved to a database
iii. Click of a button, send patents for subject matter expert analysis.

In accordance with another aspect of this invention, disclosed is a classification method and system. Previous systems cannot classify a patent with marketing material because the documents are too different in the languages that are contained in the documents. Current thesauruses lack the ability to draw the connection between such diverse documents that might be referring to the same functionality in an end product. For example, a data sheet describing the functionality of a semiconductor chip cannot be classified or matched with the patent claiming that functionality in the claims. This is solved by having the end user define the “different languages” within the English language that might be used in documents classified in the taxonomy that the end user is creating. For example, marketing, technical, and legal language can be separated for increased accuracy for classification. Then applying natural language processing techniques to get dissimilar documents classified together.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

The subsequent description of the preferred embodiments of the present invention refers to the attached drawings, wherein:

FIG. 1 represents a user-defined taxonomy in a tree structure as a set of nodes.

FIG. 2 represents node actions that are available to a user.

FIG. 3 represents node settings that are available to a user for defining node attributes.

FIG. 4 represents a list of fields/attributes that a user may select where the selected fields/attributes are to be returned in a find matches request.

FIG. 5 represents a list of patents that match the pattern(s) defined in the node setting.

FIG. 6 represents a list of analysis tools that are available to a user.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These descriptions and representations are the means used by those skilled in the data processing arts to most effectively convey the substance of their work to others skilled in the art. The steps described herein are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, and each coupled to a computer system bus.

The descriptions presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein. A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

An exemplary usage of the invention can be understood from the perspective of a user who manages a patent portfolio. The user creates and defines their own taxonomy, and may augment their own taxonomy by purchasing a taxonomy, finds valuable patents using the taxonomy according to analytic techniques, uploads analysis relevant to particular patents in a node, performs preliminary analysis on the patents, exports some patents to a spreadsheet and sends valuable patents off to experts for further analysis.

One aspect of the invention is to have the nodes populated with patents and have the system export the patents from the nodes into a spreadsheet. The tasks associated with this aspect involve the following steps:

1. System Access Functionality
A. An administrator creates a new group or sub-group
B. User is presented with his/her taxonomies
C. User creates a new taxonomy

2. Taxonomy Functionality
A. Parent node is populated with patents from a patent database based on the settings parameters found in the parent node. The patents are shown in the spreadsheet/output tab, patents sub tab.
B. Child nodes are populated with patents found in its parent node based on the settings parameters found in the child node. The patents are shown in the spreadsheet/output tab, patents sub tab.
C. Each node contains a settings window, spreadsheet output tab, graphical output tab
D. User finds a taxonomy to purchase (copy and own, copy and rent)
E. User adds a node to one of the children nodes in the taxonomy

3. Patent Settings Tab Functionality
A. User creates the title “Entire Client X patent portfolio”
B. With the patent search field of assignee, select Client X as the Assignee.
C. Selects the purpose of the taxonomy as one of the following “Project, Training, Competitive Intelligence, Information”. (Public & private taxonomies)
D. Select automatic and manual input into the parent node
E. User sets notifications if new patents are added to the node that an email is sent notifying the user.
F. User copies and pastes patents into the manual input field.

4. Patent Spreadsheet/Output Tab Functionality
A. Taxonomy is populated with relevant patents
B. There is a red line in the spreadsheet/output tab. All expired patents are below the red line, patents that are 3 years from expiration are pink
C. Show the following jurisdictions
D. Bibliographic data, Internal data (analysis (novelty, utilization, companies' products), standards (essential, optional, commercial, declared), encumbrances, document checked out), Filter capability,
E. Upload spreadsheet scenario
F. Export to a spreadsheet scenario
G. Clicks the button to send patents off to experts for further analysis
H. End user selects whether to label a patent is being used in a project, reserved, just interested
I. There is a ranking per patent, relevance to the node parameters

5. Analysis functionality, from the spreadsheet/output tab the user has a toolbar from which they select the desired tool to implement on the patents in the node.
A. Patent prioritization tool, expert system asks the end user:
   1. Would you like the patents below the red line included in the analysis?
   2. If there are multiple jurisdictions in the node, which jurisdiction would you like to use for the analysis?
   3. Would you like to have just one family member analyzed?
   4. After the questions are completed, user pushes the analyze button.
   5. Patents are sorted based on the prioritization tool parameters. These parameters involve objective patent metadata such as patent family size, citations to/from the patent, number of claims, estimated remaining life and claim word count, which can be used to prioritize patents that likely deserve deeper analysis by technical domain experts.
   6. The User can combine and customize the patent metadata of step 5 via control parameters (e.g. mixing weights, thresholds, derived functions from patent metadata, etc.), but the tool starts from a default prioritization function. For any given combination of control parameters, the same prioritization function should be applied to all patents in a project.
   7. The prioritization function is used to rank order the patents and can be used to select a target number of patents according to a relative rank of the patent. If a target number of patents is defined, the prioritization tool should add a column to the spreadsheet/output tab with a Y/N to indicate the selected patents via the prioritization tool.
   8. The user may optionally go back to steps 6-7 to adjust the control parameters depending on project constraints, as well as prioritize groups of patents (e.g. having similar values of the prioritization function) based on selected patent metadata (e.g. claim word count).
   9. The tool should save the user-defined parameters as user's prioritization tool.
   10. The user's prioritization tool shows up in the toolbar as a new button.
B. S Curve Analysis
   1. Do you want all family members analyzed or just one jurisdiction?
   2. Tool determines the oldest and the newest patent in the node, then asks: Is this the desired date range? If not, user can input a date range.
   3. After the questions are completed, user pushes the analyze button.
   4. Output graph is shown in the “Graphical Output” tab.
   5. User selects output graph, copies and pastes the graph into PowerPoint.
   6. End user selects embryonic, growth, maturation, aging phases
   7. The end user selects a set of patents from the S curve analysis. The selected patents can be dropped into a new child node.
   8. End user selects patents in the embryonic and growth stages
   9. Places the embryonic and growth stage patents into the newly created child node.

6. User changes definition of a particular node settings of the purchased or copied taxonomy.

7. User copies a taxonomy from another user in their own group

8. Analysis window
A. Highlight novelty
B. List of suggested infringing products
C. List of suggested potential related art
D. Type in URL of product using the invention

Implied Functionality:
i. Admin that set up the user
ii. Admin can create groups
iii. Copy/alias/share functionality
iv. API to Google patents
   a. Break the class codes down into primary, secondary, tertiary, quaternary, quinary, senary, etc.
   b. Citations received are updated when the database is updated automatically
   c. Citations are broken down into examiner vs. assignee citations
   d. Haris' assignment database code
   e. Maintenance fee database
   f. Groups by family code
   g. Each claim is individually stored in the database
v. When the end user creates a group, subgroup, user, taxonomy or process in the Explorer window; the user defines the group, subgroup, user, taxonomy or process with some of the different characteristics:
   a. Title
   b. Description
   c. Role
   d. Purpose
vi. If the end user is defining himself/herself as the user then the different characteristics are:
   a. Job Title
   b. Job description
   c. Job role as it relates to this group and the group task
   d. Job purpose

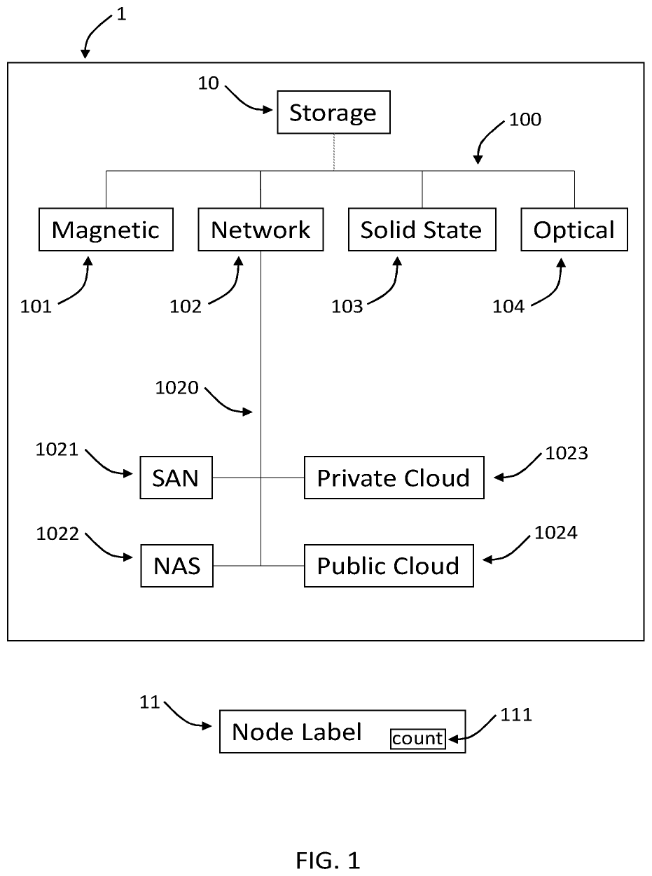

FIG. 1 is a diagram illustrating an exemplary taxonomy 1. The taxonomy is represented as a hierarchical tree structure and is composed of a parent node 10, child nodes 101, 102, 103 and 104, where child node 102 is composed of child nodes 1021, 1022, 1022 and 1023. Lines 100 and 1020 connect the parent nodes to the child nodes. In the preferred embodiment, the tree structure is drawn by a user using a graphical user interface. In alternative embodiments, the tree structure is imported into the system. In the preferred embodiment, each node has a label 11 and a count 111, where the count represents the number of records that match search criteria. It should be understood that the exemplary taxonomy 1 is merely an illustration of how a user might construct a hierarchical tree structure for storage technologies. In accordance with this invention, the taxonomy builder is capable of representing arbitrary technologies and knowledge. A novel aspect of this invention can be appreciated by comparing the graphical and information-rich hierarchical tree structure to the International Patent Classification (IPC) tree structure where it is difficult to determine the popularity for each classification code, there is no ability to understand and modify the definition for each classification code, and there in so ability to ascribe search criteria to each classification code.

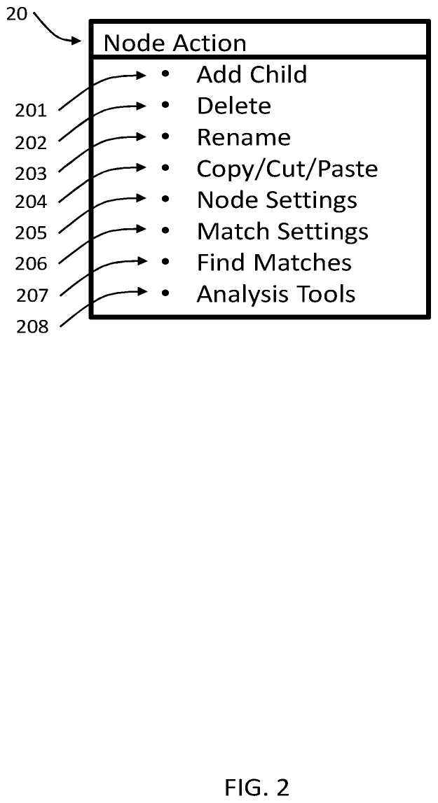

To support building the tree structure and analysis, FIG. 2 is a diagram illustrating a list of node actions 20 that a user selects. Many of the node actions are obvious to one familiar with graphical user interfaces. To add a child node to the selected node, a user selects “Add Child” 201. To delete a node, a user selects “Delete” 202. To rename a node, a user selects “Rename” 203. To copy/cut/paste a node from one location to another locater, a user selects “Copy/Cut/Paste” 204. Some of the novel aspects of the invention are represented by the actions “Node Settings” 205, “Match Settings” 206, “Find Matches” 207 and “Analysis Tools” 208.

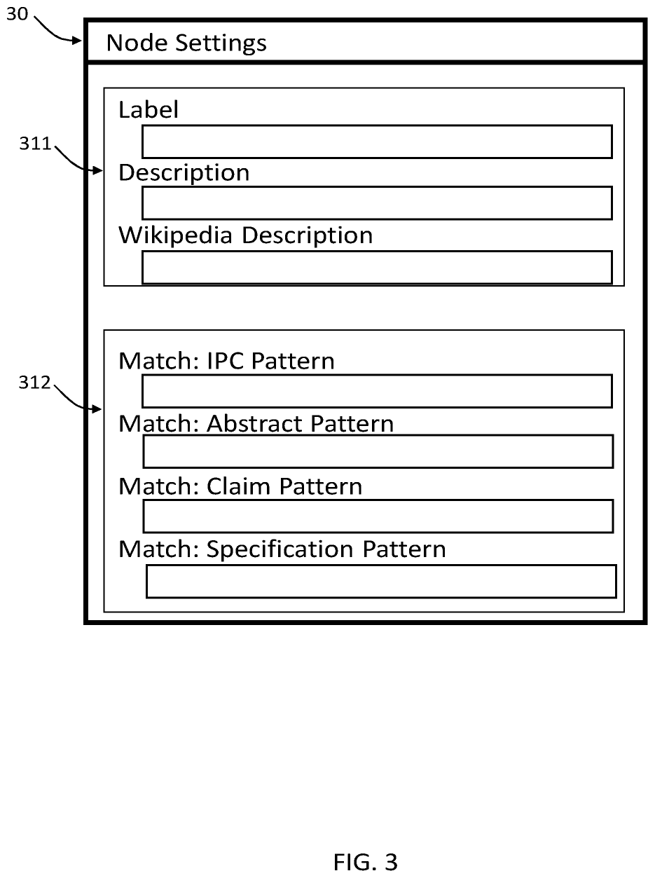

FIG. 3 is a diagram illustrating a list of node settings 30 that a user configures. Exemplary fields that a user configures include a label for the node and descriptive information 311. A novel aspect of this invention is that associated with each node is a set of search criteria 312. As shown in FIG. 3 312, the search criteria provide for user-entered patterns that are combined together to search a data repository. In the preferred embodiment, the search criteria are logically and-ed together. In alternative embodiments, the search criteria are configured by the user as a series of Boolean logic operators (and/or/not), with support for wildcard searches, fuzzy searches based on Levenshtein Distance algorithm, proximity searches where search terms are within a user-specified distance away from each other as well as range searches for dates and numerical values.

As shown in FIG. 3 312, search patterns are relevant to the data repository. In the preferred embodiment, the data repository includes published patent applications. In alternative embodiments, the data repository includes granted patents, but could also include any data repository that is electronically searchable based on a combination of search patterns. patterns. In the preferred embodiment, the available set of search patterns are pre-configured based on the selected data repository.

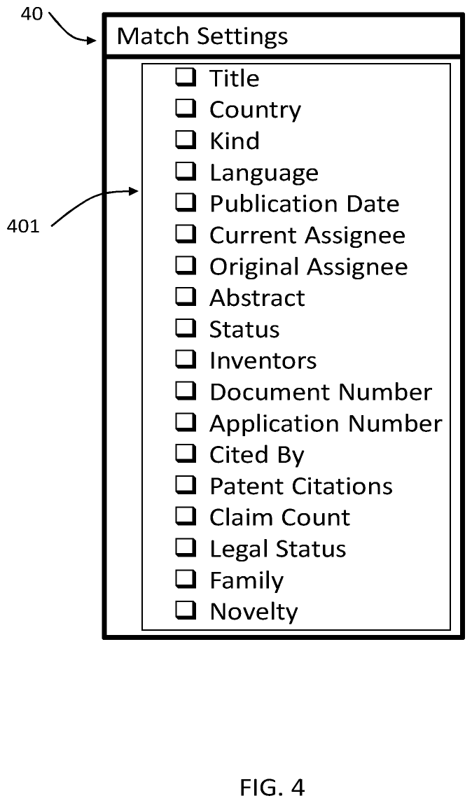

FIG. 4 is a diagram 40 illustrating a list of search result fields 401 that are available for a user to select. In the preferred embodiment, the available set of search result fields are pre-configured based on the selected data repository.

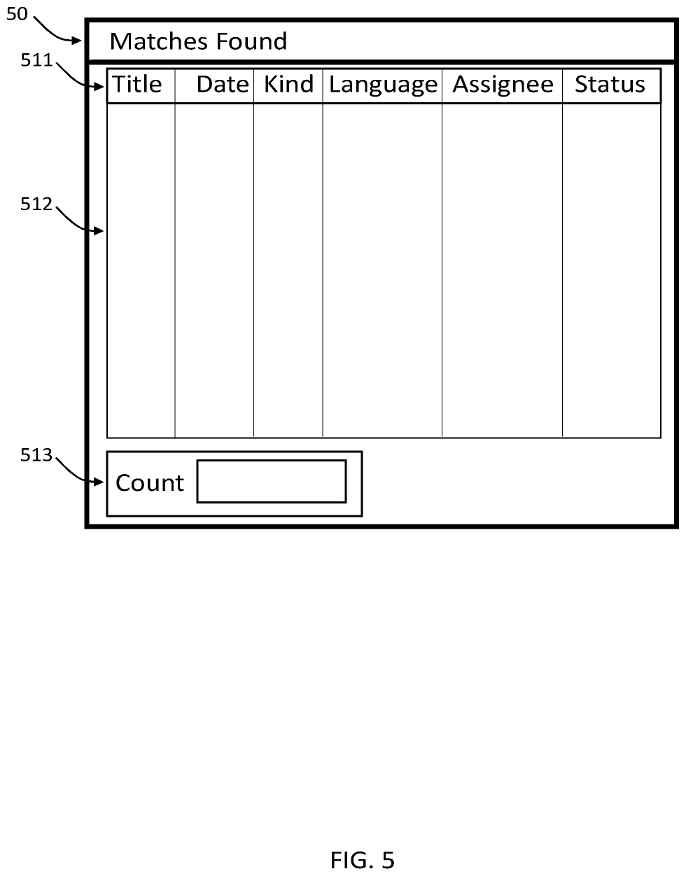

FIG. 5 is a diagram illustrating the search results 50 that become available when the user selects the “Find Matches” node action 207 as depicted in FIG. 2. The search result fields 511 are based on user selection as shown in FIG. 4 401. In addition to showing the search results, a count 513 is also displayed in the preferred embodiment. In alternative embodiments, this count is displayed adjacent to the node label as depicted in FIGS. 1 11 and 111.

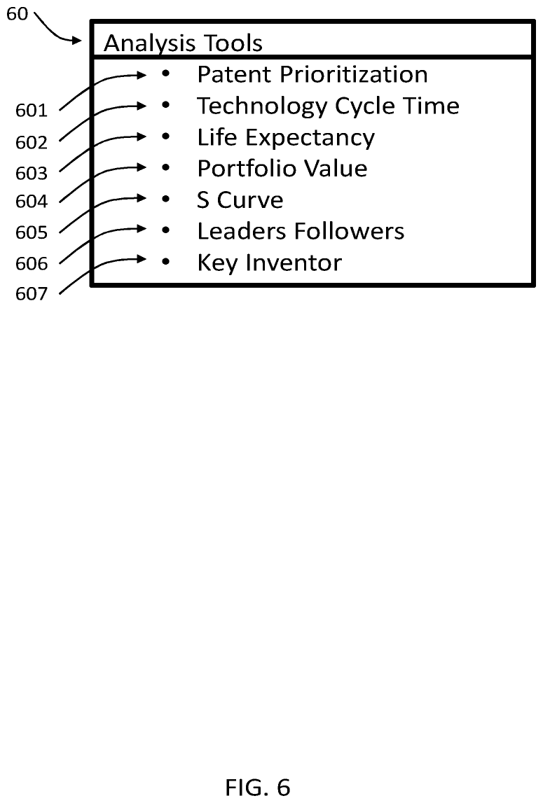

FIG. 6 is a diagram illustrating a list of analysis tools 60 that a user applies to the search results associated with the node.

The patent prioritization tool 601 in FIG. 6 provides a ranking of potentially valuable patents using bibliometrics parameters such as listed below for the patents found in the taxonomy node. The end user can also select parameters and build their own prioritization tool using different parameters that are made available to them. The bibliometrics parameters include the following:
Maintenance fee payments on patent
Size of patent family (number of patents in patent family)
Citation distribution, which is a curve fit, distribution analysis or other calculation based on the citation distribution over time
Present date
Claim word count
Filing date of target patent
Detectability of the patent
Market royalty base of the invention
Difficulty with which the invention may be designed around by competitors
Claim breadth
Ease of implementation of invention (technology barriers+financial barrier to adoption of invention)

The technology cycle time analysis tool 602 in FIG. 6 uses electronic documents found in the taxonomy node to provide the end user the ability to determine which organizations are developing technology faster or slower. FIG. 6 is a diagram illustrating a list of analysis tools 60 that a user applies to the search results associated with the node.

The life expectancy analysis tool 603 in FIG. 6 uses electronic documents found in the taxonomy node to provide a chart which shows the distribution of the number of patents and how many years are left until expiration. This tool also produces an average amount of time left before the portfolio is to expire.

The portfolio value analysis tool 604 in FIG. 6 uses electronic documents (market reports, stock information, technical publications, and patents) found in the taxonomy node to provide a quantified financial valuation for a patent portfolio.

The S curve analysis tool 605 in FIG. 6 uses electronic documents found in the taxonomy node to provide the end user with a view of the distribution of documents across time.

The leaders followers analysis tool 606 in FIG. 6 uses electronic documents found in the taxonomy node to provide the end user with an understanding as to whether an organization is an imitator or pioneer or whether an organization protects or teaches in a given technology domain.

The key inventor analysis tool 607 in FIG. 6 uses electronic documents found in the taxonomy node to provide to the end user a list of who are the key inventors.

What is claimed is:

1. A computer-implemented method for generating taxonomies, the method comprising the following operations:
providing a graphical interface to a user for creating a hierarchical tree structure, wherein the hierarchical tree structure is comprised of nodes and lines connecting the nodes;
associating a label to each of the nodes;
associating descriptive information to each of the nodes;
associating search criteria to each of the nodes;
searching at least one data repository according to the search criteria, wherein the at least one data repository is a member of a pre-configured set of data repositories; and
presenting search results to the user on the graphical display, wherein attributes of the search results are selectable by the user from a pre-configured set of attributes.

2. The method of claim 1, wherein the at least one data repository comprises patent applications.

3. The method of claim 1, wherein the at least one data repository comprises granted patents.

4. The method of claim 1, wherein the search is automatically performed in response to the user updating the search criteria for at least one node.

5. The method of claim 1, wherein the node label includes a count of the number of records that match the search criteria.

6. The method of claim 1, wherein the search results for a node and children of that node are subject to analysis, the analysis being selected from a group consisting of patent prioritization, technology cycle time, life expectancy, portfolio value, S curve, leaders followers and key inventor.

7. An apparatus comprising:
one or more network interfaces configured to transmit and receive data on a computer network;
a processor coupled to the network interfaces and configured to execute one or more processes; and
a memory configured to store instructions executable by the processor, when executed causing the processor to perform operations comprising:
providing a graphical interface to a user for creating a tree structure, wherein the tree structure is comprised of nodes and connections between the nodes;
associating a label to each of the nodes;
associating descriptive information to each of the nodes;
associating search criteria to each of the nodes;
searching at least one data repository according to the search criteria, wherein the at least one data repository is a member of a pre-configured set of data repositories; and
presenting search results to the user on the graphical display, wherein attributes of the search results are selectable by the user from a pre-configured set of attributes.

8. The apparatus of claim 7, wherein the at least one data repository contains patent applications.

9. The apparatus of claim 7, wherein the at least one data repository contains granted patents.

10. The apparatus of claim 7, wherein the search is automatically performed in response to the user updating the search criteria for at least one node.

11. The apparatus of claim 7, wherein the node label includes a count of the number of records that match the search criteria.

12. The apparatus of claim 7, wherein the search results for a node and any children of that node are subject to analysis, the analysis being selected from a group consisting of patent prioritization, technology cycle time, life expectancy, portfolio value, S curve, leaders followers and key inventor.

13. One or more non-transitory computer readable storage media encoded with instructions that, when executed by one or more computer processors, cause the one or more computer processors to perform operations comprising:
providing a graphical interface to a user for creating a tree structure, wherein the tree structure is comprised of nodes and connections between the nodes;
associating a label to each of the nodes;
associating descriptive information to each of the nodes;
associating search criteria to each of the nodes;
searching at least one data repository according to the search criteria, wherein the at least one data repository is a member of a pre-configured set of data repositories; and
presenting search results to the user on the graphical display, wherein attributes of the search results are selectable by the user from a pre-configured set of attributes.

14. The non-transitory computer readable storage media of claim 13, wherein the at least one data repository contains patent applications.

15. The non-transitory computer readable storage media of claim 13, wherein the at least one data repository contains granted patents.

16. The non-transitory computer readable storage media of claim 13, wherein the search is automatically performed in response to the user updating the search criteria for at least one node.

17. The non-transitory computer readable storage media of claim 13, wherein the node label includes a count of the number of records that match the search criteria.

18. The non-transitory computer readable storage media of claim 13, wherein the search results for a node and any children of that node are subject to analysis, the analysis being selected from a group consisting of patent prioritization, technology cycle time, life expectancy, portfolio value, S curve, leaders followers and key inventor.
